(19) United States
(12) Patent Application Publication
(10) Pub. No.: US 2018/0066966 A1
(43) Pub. Date: Mar. 8, 2018

(54) DISPLACEMENT MEASURING DEVICE AND METHOD OF MEASURING DISPLACEMENT

(71) Applicant: TAIYO YUDEN CO., LTD., Tokyo (JP)

(72) Inventors: Katsuhiro Oyama, Tokyo (JP); Fuyuki Miyazawa, Tokyo (JP); Yasuhito Hagiwara, Tokyo (JP); Takaki Hamamoto, Tokyo (JP); Isao Matsuda, Tokyo (JP)

(73) Assignee: TAIYO YUDEN CO., LTD., Tokyo (JP)

(21) Appl. No.: 15/692,374

(22) Filed: Aug. 31, 2017

(30) Foreign Application Priority Data
Sep. 6, 2016 (JP) 2016-173586

(51) Int. Cl. G01D 5/38

(52) U.S. Cl. CPC G01D 5/38; G01D 5/266

(57) ABSTRACT

A displacement measuring device according to the present invention includes a diffraction grating that receives light from a light source, the first diffraction grating including a plurality of grating pattern regions respectively having prescribed diffraction grating patterns, grating pitches of the plurality of grating pattern regions being equal to one another, the plurality of grating pattern regions being arranged in a direction that is orthogonal to a direction in which the prescribed diffraction grating patterns extend; a second diffraction grating that produces interference light upon receiving diffracted light rays emitted from the first diffraction grating; and a light detector that receives the interference light emitted from the second diffraction grating, the light detector including a plurality of photodetectors, the plurality of photodetectors being arranged along a first direction that is orthogonal to a direction in which interference fringes created by the interference light extend.

### BACKGROUND OF THE INVENTION

### Technical Field

The present invention relates to a displacement measuring device and a method of measuring displacement using optical interference.

### Background Art

Strain gauges that use a piezoelectric semiconductor material and the like are commonly used as displacement measurement sensors for detecting small displacements. However, the resolution of strain gauges is limited to several μm. Optical interferometers that use optical interference are one type of displacement measurement sensors that have a resolution of less than or equal to 1 μm (see Patent Documents 1 to 6, for example).

### RELATED ART DOCUMENTS

### Patent Documents

Patent Document 1: Japanese Patent Application Laid-Open Publication No. 2002-048602

Patent Document 2: Japanese Patent Application Laid-Open Publication No. H11-108697

Patent Document 3: Japanese Patent Application Laid-Open Publication No. H07-318372

Patent Document 4: Japanese Patent Application Laid-Open Publication No. H08-043137

Patent Document 5: Japanese Patent Application Laid-Open Publication No. 2000-146705

Patent Document 6: Japanese Patent Application Laid-Open Publication No. H06-300520

### SUMMARY OF THE INVENTION

Even in optical interferometers, there is demand for higher detection accuracy (levels of ±5 nm, for example). However, while achieving higher detection accuracy requires decreasing the margins between optical elements such as diffraction gratings and photodiodes, there is also demand for increased margins in actual optical interferometer use and production applications.

In light of the foregoing, the present invention aims to provide a displacement measuring device and a method of measuring displacement that make it possible to achieve both improved detection accuracy and increased margins. Accordingly, the present invention is directed to a scheme that substantially obviates one or more of the problems due to limitations and disadvantages of the related art.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a displacement measurement device, including a first diffraction grating that receives light from a light source, the first diffraction grating including a plurality of grating pattern regions respectively having prescribed diffraction grating patterns, grating pitches of the plurality of grating pattern regions being equal to one another, the plurality of grating pattern regions being arranged in a direction that is orthogonal to a direction in which the prescribed diffraction grating patterns extend; a second diffraction grating that produces interference light upon receiving diffracted light rays emitted from the first diffraction grating; and a light detector that receives the interference light emitted from the second diffraction grating, the light detector including a plurality of photodetectors, the plurality of photodetectors being arranged along a first direction that is orthogonal to a direction in which interference fringes created by the interference light extend

In this configuration, arranging the plurality of photodetectors in the direction in which the interference fringes extend reduces the effects of Z-tilt (that is, inclination relative to the optical axes of the first diffraction grating and the second diffraction grating) on the amounts of phase shift applied to light by the plurality of grating pattern regions of the first diffraction grating, thereby improving the Z-tilt margin.

The plurality of photodetectors may be separated from one another along the first direction by gaps equal to widths of the photodetectors in the first direction.

In this configuration, the gaps between the plurality of photodetectors are relatively large, and therefore even if defocus occurs (that is, positional shifts relative to the optical axis directions of the first diffraction grating and the second diffraction grating), light having the amounts of phase shift applied by the plurality of grating pattern regions of the first diffraction grating is prevented from reaching the other photodetectors, thereby improving the defocus margin.

The plurality of grating pattern regions may include a first grating pattern region, a second grating pattern region, and a third grating pattern region, the second grating pattern region having a diffraction grating pattern that creates a 90° phase shift in the interference light relative to the interference light created by a diffraction grating pattern of the first grating pattern region, and the third grating pattern region having a diffraction grating pattern that creates a 180° phase shift in the interference light relative to the interference light at the corresponding photodetector created by the diffraction grating pattern of the first grating pattern region.

In this configuration, because the first grating pattern region and the third grating pattern region create a 180° phase shift, adding together the light waveforms that pass through these regions makes it possible to extract and remove fluctuations in the light caused by the light source.

The plurality of photodetectors may include a first photodetector, a second photodetector, and a third photodetector, the first photodetector receiving light emitted from the first grating pattern region, the second photodetector receiving light emitted from the second grating pattern region, and the third photodetector receiving light emitted from the third grating pattern region.

In this configuration, the photodetectors respectively receive the interference light in which phase shifts have been applied by the first diffraction grating, thereby making it possible to calculate displacement of the second diffraction grating relative to the first diffraction grating on the basis of the output of the respective photodetectors.

The displacement measuring device described above may further include an optical member that includes a parallel pair of reflective surfaces facing one another and that is configured to respectively reflect ±mth-order diffracted light rays off of the pair of reflective surfaces to guide the light rays to the second diffraction grating, the ±mth-order diffracted light rays being a prescribed order of diffracted light rays among a plurality of orders of the diffracted light rays emitted from the first diffraction grating, and m being a natural number.

The displacement measuring device described above may further include a processing circuit that calculates a displacement of the second diffraction grating relative to the first diffraction grating on the basis of output of the plurality of photodetectors.

In another aspect, the present disclosure provides a method of measuring displacement, including: preparing a displacement measuring device that includes: a first diffraction grating that receives light from a light source, the first diffraction grating including a plurality of grating pattern regions respectively having prescribed diffraction grating patterns, grating pitches of the plurality of grating pattern regions being equal to one another, the plurality of grating pattern regions being arranged in a direction that is orthogonal to a direction in which the prescribed diffraction grating patterns extend; a second diffraction grating that produces interference light upon receiving diffracted light rays emitted from the first diffraction grating; and a light detector that receives the interference light emitted from the second diffraction grating, the light detector including a plurality of photodetectors, the plurality of photodetectors being arranged along a first direction that is orthogonal to a direction in which interference fringes created by the interference light extend; and calculating a displacement of the second diffraction grating relative to the first diffraction grating on the basis of output of the plurality of photodetectors.

As described above, the present invention makes it possible to provide a displacement measuring device and a method of measuring displacement that make it possible to achieve both improved detection accuracy and increased margins. It is to be understood that both the foregoing general description and the following detailed description are exemplary and explanatory, and are intended to provide further explanation of the invention as claimed.

### BRIEF DESCRIPTION OF THE DRAWINGS

FIG. 1 is a perspective view of a displacement measuring device according to an embodiment of the present invention.

FIG. 2 is a plan view of the aforementioned displacement measuring device.

FIG. 3 is a plan view of a first diffraction grating included in the aforementioned displacement measuring device.

FIG. 4 schematically illustrates grating lines formed in the first diffraction grating of the aforementioned displacement measuring device.

FIG. 5 is a plan view of a second diffraction grating included in the aforementioned displacement measuring device.

FIG. 6 is a plan view of a PDIC included in the aforementioned displacement measuring device.

FIG. 7 schematically illustrates light entering the first diffraction grating of the aforementioned displacement measuring device.

FIG. 8 schematically illustrates light incident on the PDIC of the aforementioned displacement measuring device.

FIG. 9 schematically illustrates interference fringes formed in the light incident on the PDIC of the aforementioned displacement measuring device.

FIG. 10 is a graph showing the output of photodetectors included in the PDIC of the aforementioned displacement measuring device.

FIG. 11 is a graph showing waveforms calculated from the output of the photodetectors in the PDIC of the aforementioned displacement measuring device.

FIG. 12 is a plan view of a PDIC included in a displacement measuring device according to a comparison example.

FIG. 13 is a graph showing the relationship between Z-tilt and detection error in the comparison example.

FIG. 14 is a table showing the conditions required to achieve a detection accuracy of ±2 nm in the comparison example.

FIG. 15 schematically illustrates a defocus effect in the PDIC of the displacement measuring device according to an embodiment of the present invention.

FIG. 16 is a graph showing the relationship between defocus and Lissajous error as measured by the displacement measuring device according to the aforementioned embodiment of the present invention.

FIG. 17 is a table showing the conditions required to achieve a detection accuracy of ±2 nm in the same displacement measuring device.

FIG. 18 schematically illustrates the spacing of the PDs in the PCID according to embodiments of the present invention.

FIG. 19 schematically illustrates the positional relationship between the first diffraction grating and the PDs of the PCID in a displacement measuring device according to another embodiment of the present invention.

FIG. 20 is a graph showing the relationship between defocus and Lissajous error as measured by the displacement measuring device of the embodiment of FIG. 19.

FIG. 21 is a table showing the conditions required to achieve a detection accuracy of ±2 nm in the displacement measuring device of the embodiment of FIG. 19.

### DETAILED DESCRIPTION OF EMBODIMENTS

Next, an embodiment of the present invention will be described with reference to figures.

<Overall Configuration of Displacement Measuring Device>

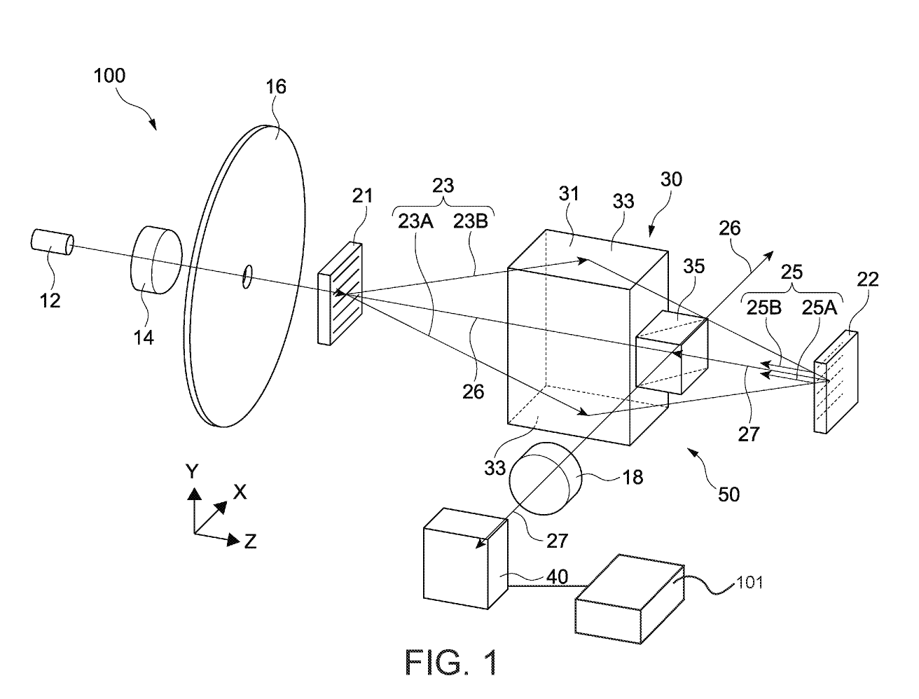

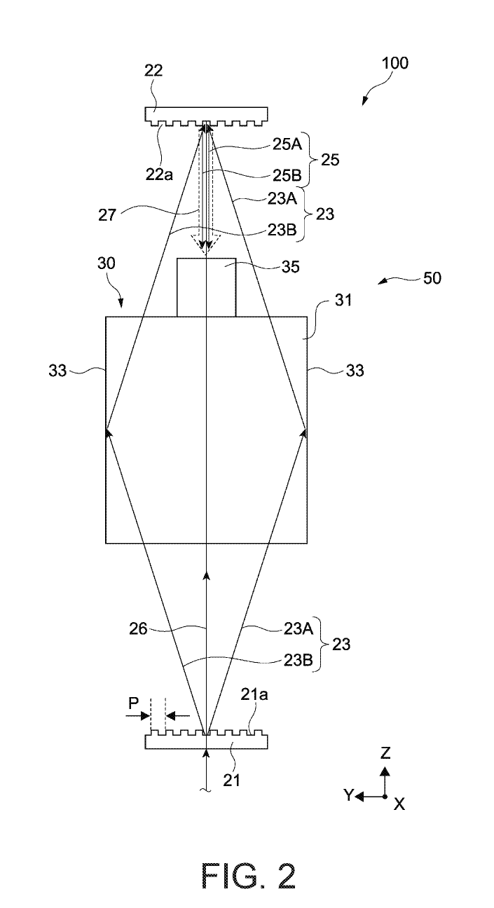

FIG. 1 is a perspective view illustrating a displacement measuring device 100 according to an embodiment of the present invention. FIG. 2 illustrates the displacement measuring device 100 as viewed from the X direction in FIG. 1. The displacement measuring device 100 includes a light source 12, an optical unit 50, and a photodetector integrated circuit (PDIC) 40. Note that in FIG. 2, some components are not explicitly illustrated.

The light source 12 is a laser diode (LD) or a light-emitting diode (LED) and is driven by a driver (not illustrated in the figure). Here, the light source 12 is a light-emitting element that emits laser light set to a center wavelength of 400 nm to 900 nm, for example, but the light source 12 is not limited to having this configuration.

The optical unit 50 includes a collimator lens 14, an aperture member 16, a first diffraction grating 21, a prism mirror 35, an optical member 30, a second diffraction grating 22, and a collimator lens 18, for example.

The collimator lens 14 converts light emitted from the light source 12 into parallel light. An optical system for generating parallel light includes at least the light source 12 and the collimator lens 14. The aperture member 16 reduces the beam diameter of the light emitted from the collimator lens 14 to a prescribed beam diameter. From a theoretical perspective, the collimator lens 14 and the aperture member 16 do not necessarily need to be included.

As illustrated in FIG. 2, the first diffraction grating 21 and the second diffraction grating 22 respectively have a plurality of grating lines (grating grooves) 21a and 22a that are formed at the same pitch P and running in the same direction. The grating lines 21a and 22a will be described in more detail later. The first diffraction grating 21 and the second diffraction grating 22 are configured so as to be displaceable relative to one another in the arrangement direction of the grating lines 21a and 22a (the Y direction in the figure). The displacement measuring device 100 measures this relative displacement.

The first diffraction grating 21 is a transmissive diffraction grating. The first diffraction grating 21 emits diffracted light upon receiving the light that exits from the aperture member 16. This diffracted light includes diffracted light of a plurality of orders, such as ±first-order, ±second-order, . . . , ±nth-order (where n is a natural number) diffracted light. This diffracted light also includes zero-order diffracted light (hereinafter, “zero-order light”) 26 that passes straight through the first diffraction grating 21.

For convenience, the diffracted light that travels to the right of the line that runs parallel to the Z axis and passes through the centers of the first diffraction grating 21 and the second diffraction grating 22 in FIG. 2 will be referred to as positive (+) diffracted light, and the diffracted light that travels to the left of this line will be referred to as negative (−) diffracted light.

The optical member 30 is configured to reflect ±mth-order diffracted light 23 (which is one prescribed order of diffracted light among the orders of diffracted light emitted from the diffraction grating 21) and guide that light to the second diffraction grating 22. This ±mth-order diffracted light 23 is typically ±first-order diffracted light but may alternatively be ±second-order or higher-order diffracted light, for example.

The optical member 30 includes a rectangular prism-shaped light guiding member 31 and a prism mirror 35 connected thereto, for example. In other words, the light guiding member 31 and the prism mirror 35 are integrated.

The prism mirror 35 is attached to one of the side faces of the light guiding member 31 in the Z direction, for example. As illustrated in FIG. 1, the prism mirror 35 includes a mirror arranged within a transparent material at a 45° angle relative to the Z axis, for example, and reflects reflected light from the second diffraction grating 22 (described below) at a right angle towards the collimator lens 18. The prism mirror 35 also reflects the zero-order light 26 emitted from the first diffraction grating 21 in a direction away from the collimator lens 18 (such as the direction opposite to the collimator lens 18, for example) so that that light is not guided to the second diffraction grating 22.

The end faces of the light guiding member 31 in the Y direction are formed as a parallel pair of reflective surfaces 33 and 33 that face one another. The +mth-order diffracted light 23A and −mth-order diffracted light 23B produced by the first diffraction grating 21 are respectively incident on this pair of reflective surfaces 33 and 33, and the pair of reflective surfaces 33 and 33 guide this diffracted light towards the second diffraction grating 22.

The pair of reflective surfaces 33 and 33 may partially reflect or totally reflect the ±mth-order diffracted light 23 from the first diffraction grating 21. Whether the light is totally reflected depends on factors such as the wavelength of the light, the structure of the diffraction gratings, and the arrangement of the optical components. Alternatively, reflective films such as metal films may respectively be formed on the pair of reflective surfaces 33 and 33.

Still alternatively, the transparent main body of the light guiding member 31 may be removed and the pair of reflective surfaces may be two physically independent mirrors. However, using the end faces of the light guiding member 31 as the pair of reflective surfaces 33 and 33 (in other words, forming the light guiding member 31 and the pair of reflective surfaces 33 and 33 as a single integrated component) makes it easier to manufacture the light guiding member 31 that includes this pair of reflective surfaces 33 and 33. This also makes it easier to position the pair of reflective surfaces 33 and 33 relative to one another.

Similarly, although the light guiding member 31 and the prism mirror 35 may be separate, integrating these components makes it easier to manufacture the optical member 30 and also makes it easier to position the light guiding member 31 and the prism mirror 35 relative to one another.

The light guiding member 31 is made of a fused quartz material, for example. However, other glasses or transparent materials other than glass may also be used. For example, a transparent resin material can be used. It is preferable that the plane precision of the reflective surfaces 33 and 33 be λ/4 or better, where λ is the center wavelength of the light emitted by the light source 12 (λ=633 nm, for example). If the reflective surfaces 33 and 33 have poor plane precision, the desired type of interference light 27 (described below) cannot be produced, and measurement accuracy may potentially be reduced.

Moreover, the parallelism of the reflective surfaces 33 and 33 (that is, the angle therebetween) is less than or equal to 1 minute, and it is preferable that this angle be less than or equal to 30 seconds. The parallelism of the reflective surfaces 33 and 33 is another important factor in producing interference light 27 of the desired type.

The width of the reflective surfaces 33 and 33 of the light guiding member 31 in the direction in which the first diffraction grating 21 and the second diffraction grating 22 are arranged (that is, the Z direction) can be set to 5 mm to 10 mm, for example, and the width in the direction orthogonal to that direction (that is, the X direction) can be set to 2 mm to 5 mm, for example. The dimensional tolerance for these dimensions is ±0.1 mm. In this case, the pitch of the grating lines of the first diffraction grating 21 and the second diffraction grating 22 is set to 1 μm to 5 μm, where it is preferable that the pitch be 1.5 μm and more preferable that the pitch be 2 μm. The width in the Z direction is set according to factors such as the wavelength of the light, the structure of the diffraction gratings, and the arrangement of the optical components.

The second diffraction grating 22 is a reflective diffraction grating. The second diffraction grating 22 produces interference light 27 upon receiving the ±mth-order diffracted light 23 emitted from the optical member 30. More specifically, as illustrated in FIG. 2, the second diffraction grating 22 produces ±pth-order diffracted light upon receiving the +mth-order diffracted light 23A (where p and m are natural numbers). The second diffraction grating 22 also produces ±pth-order diffracted light upon receiving the −mth-order diffracted light 23B.

Here, the reflective second diffraction grating 22 may be made primarily of a transparent material and have a metal film formed on the surface of the grating pattern region of the diffraction grating or may be made primarily of a metal.

Note that among the ±pth-order diffracted light (diffracted light other than zero-order light) emitted from the second diffraction grating 22, FIG. 2 only depicts ±m'th-order diffracted light 25 (25A and 25B). Here, m' indicates the same order as the order indicated by m for the diffracted light reflected by the pair of reflective surfaces 33 and 33. The apostrophe (') is appended to the orders of diffracted light emitted from the second diffraction grating 22 for convenience to provide differentiation from the orders of diffracted light emitted from the first diffraction grating 21; the orders themselves are the same.

More specifically, the +m'th-order diffracted light 25A is produced when the +mth-order diffracted light 23A from the first diffraction grating 21 reaches the second diffraction grating 22. Similarly, the −m'th-order diffracted light 25B is produced when the −mth-order diffracted light 25A from the first diffraction grating 21 reaches the second diffraction grating 22. The +m'th-order diffracted light 25A and the −m'th-order diffracted light 25B are produced on the same light path (such as the Z direction). In other words, the ±mth-order diffracted light 23 from the first diffraction grating 21 is respectively reflected by the pair of parallel reflective surfaces 33 and 33 of the light guiding member 31, which then results in the second diffraction grating 22 producing the ±m'th-order diffracted light 25 in the Z direction.

As described above, the ±mth-order diffracted light 23 is typically ±first-order diffracted light, and therefore the ±m'th-order diffracted light 25 is also ±first-order diffracted light. The +m'th-order diffracted light 25A and the −m'th-order diffracted light 25B interfere with one another, thus producing the interference light 27.

The interference light 27 emitted from the second diffraction grating 22 enters the prism mirror 35 and is then reflected towards the collimator lens 18. The collimator lens 18 focuses the interference light received from the prism mirror 35 on the PDIC 40.

The PDIC 40 detects the interference light 27 emitted from the second diffraction grating 22. The PDIC 40 will be described in more detail later, but when the first diffraction grating 21 and the second diffraction grating 22 are moved relative to one another in the Y direction, the PDIC 40 receives light amounts (corresponding to light intensity), which periodically change such that one set of light and dark constitutes one period for each one pitch's worth of displacement of the grating lines 21a (22a). This periodic waveform is typically a sine curve. The PDIC 40 then outputs a voltage signal having the same waveform to a processing circuit 101 shown in FIG. 1.

This processing circuit (not illustrated in the figures) includes an AD converter and an arithmetic processing circuit, for example. The arithmetic processing circuit outputs displacements in accordance with the voltage signal described above. The AD converter and the arithmetic processing circuit may be integrated together with the PDIC 40.

As described above, in the displacement measuring device 100 that includes the optical unit 50 according to the present embodiment, mth-order diffracted light (diffracted light of a prescribed order) is respectively reflected by the parallel pair of reflective surfaces 33 and 33 formed facing one another in the light guiding member 31 and is thus guided to the second diffraction grating 22. Moreover, the prism mirror 35 prevents the zero-order light 26 from reaching the PDIC 40. In other words, substantially only the ±mth-order diffracted light 23 reaches the second diffraction grating 22, and the other orders of diffracted light including the zero-order light 26 that are not needed for measuring displacements are mechanically blocked. This makes it possible to substantially eliminate noise due to unneeded light reaching the PDIC 40, thereby making it possible to increase the displacement measuring accuracy.

<First Diffraction Grating and Second Diffraction Grating>

Next, the first diffraction grating 21 and the second diffraction grating 22 will be described in more detail.

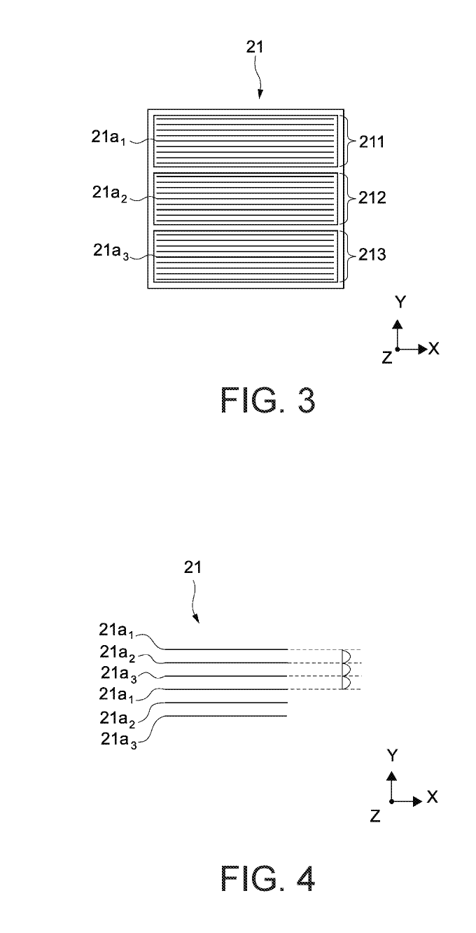

FIG. 3 is a plan view of the first diffraction grating 21. As illustrated in FIG. 3, the first diffraction grating 21 includes three grating pattern regions 211, 212, and 213 arranged in the Y direction. Each grating pattern region includes a plurality of the grating lines 21a that extend in the X direction. Below, the grating lines 21a formed in the grating pattern region 211 will be referred to as grating lines 21a₁, the grating lines 21a formed in the grating pattern region 212 will be referred to as grating lines 21a₂, and the grating lines 21a formed in the grating pattern region 213 will be referred to as grating lines 21a₃.

The pitches P (see FIG. 2) of the grating lines 21a formed in each grating pattern region are equal. Here, “the pitches are equal” means that each pitch includes an error of less than or equal to ±2%. Also note that although the number of the grating lines 21a is not particularly limited, in practice this number is relatively large.

The grating lines 21a are respectively formed in the grating pattern regions 211, 212, and 213 such that their respective phases in their spatial periodicity are shifted in the direction in which the grating lines 21a are arranged (the Y direction) by a prescribed distance of less than one pitch.

FIG. 4 schematically illustrates the pitches of the grating lines 21a that would be disposed in the entire region, if, hypothetically, the grating lines 21a in each grating pattern region were formed spanning across the entire first diffraction grating 21 beyond their respective regions. As illustrated in FIG. 4, in such a case, the grating lines 21a₁, the grating lines 21a₂, and the grating lines 21a₃ would be each shifted by ⅓ of one pitch.

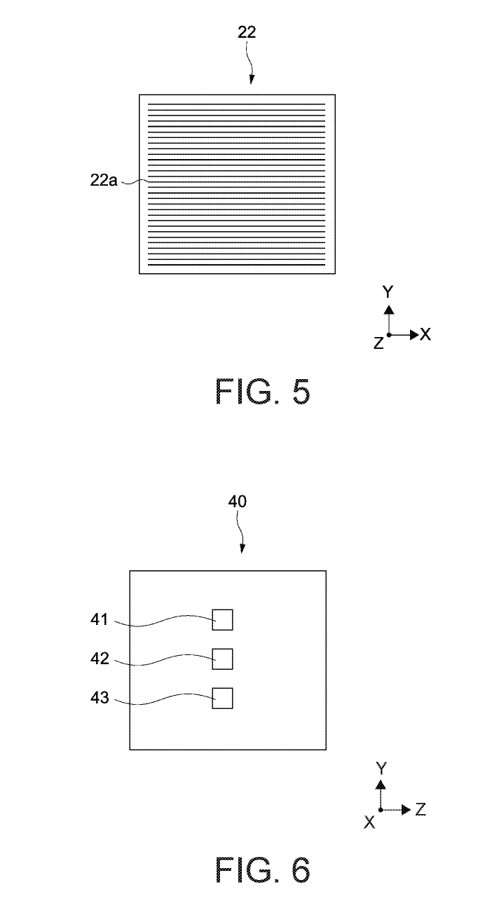

FIG. 5 is a plan view of the second diffraction grating 22. As illustrated in FIG. 5, the second diffraction grating 22 includes a plurality of the grating lines 22a that extend in the X direction. Also note that although the number of the grating lines 22a is not particularly limited, in practice this number is relatively large.

<PDIC>

Next, the PDIC 40 will be described in detail. FIG. 6 schematically illustrates a light-receiving face of the PDIC 40. As illustrated in FIG. 6, on the light-receiving face of the PDIC 40, three photodetectors (PDs) 41, 42, and 43 are arranged separated from one another. The PDs 41, 42, and 43 are elements that output electrical signals by means of photoelectric conversion upon receiving light. The PDs 41, 42, and 43 are arranged in the Y direction and separated from one another.

<Details of Displacement Calculation>

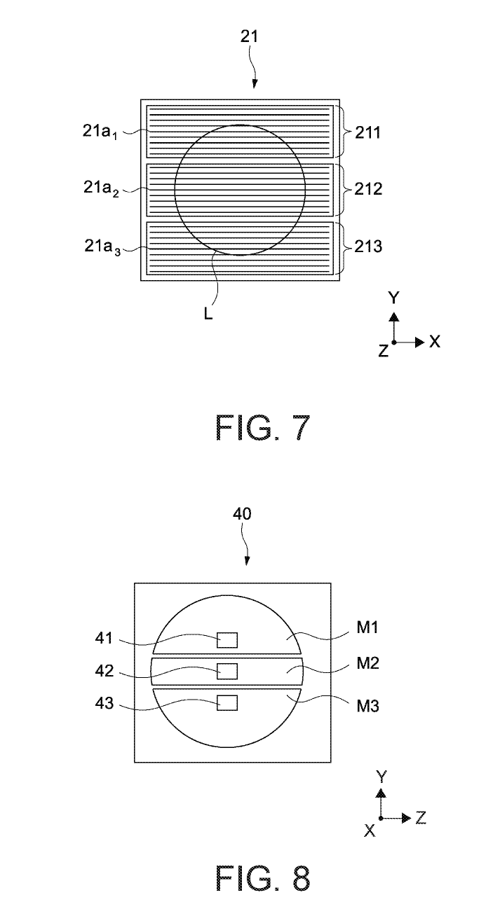

FIG. 7 schematically illustrates light from the aperture member 16 entering the first diffraction grating 21. As illustrated in FIG. 7, this incident light L enters regions of the first diffraction grating 21 that respectively include the grating pattern regions 211, 212, and 213.

As described above, the diffracted light that has passed through the first diffraction grating 21 travels through the light guiding member 31 and reaches the second diffraction grating 22, where the diffracted light becomes interference light that then travels through the prism mirror 35 and the collimator lens 18 and reaches the PDIC 40. As described above, the light guiding member 31 and the prism mirror 35 of the displacement measuring device 100 prevent diffracted light other than the ±mth-order diffracted light 23 from reaching the PDIC 40.

FIG. 8 schematically illustrates the interference light incident on the PDIC 40. As illustrated in FIG. 8, the interference light incident on the PDIC 40 is divided into three regions: a first region M1, a second region M2, and a third region M3.

The first region M1 is the region reached by light that passes through the grating pattern region 211 of the first diffraction grating 21, and the second region M2 is the region reached by light that passes through the grating pattern region 212 of the first diffraction grating 21. The third region M3 is the region reached by light that passes through the grating pattern region 213 of the first diffraction grating 21.

As illustrated in FIG. 8, the PD 41 is arranged within the first region M1, the PD 42 is arranged within the second region M2, and the PD 43 is arranged within the third region M3.

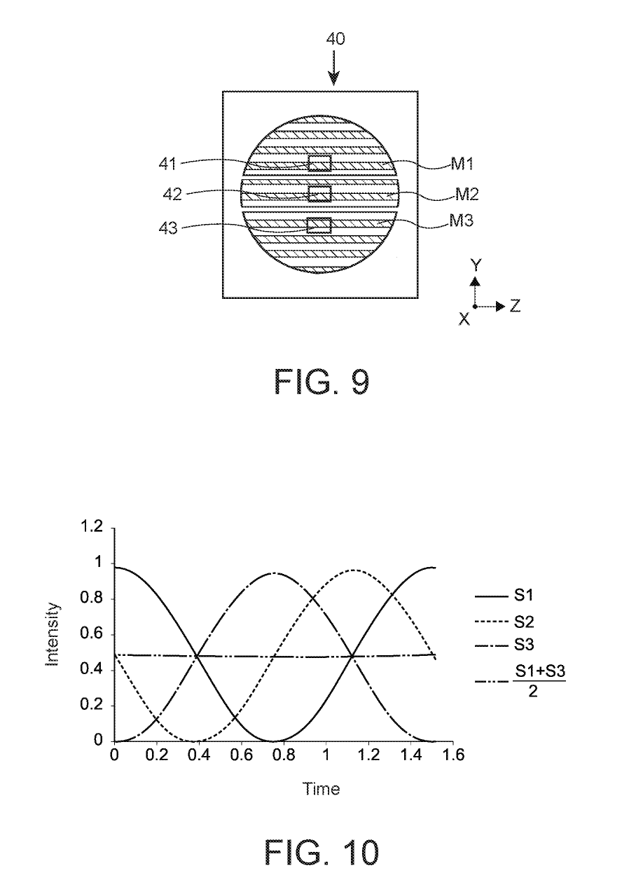

Here, the diffraction due to the first diffraction grating 21 and the second diffraction grating 22 creates interference fringes in the light incident on the PDIC 40. FIG. 9 schematically illustrates the interference fringes on the light-receiving face of the PDIC 40, where the hatching indicates dark regions among the light and dark regions in the interference fringes. As illustrated in FIG. 9, the interference fringes extend in the Z direction. Because the grating lines 21a in the grating pattern regions 211, 212, and 213 are each shifted by ⅓ of one pitch, as described above, the interference fringes in the first region M1, the second region M2, and the third region M3 are shifted relative to one another.

When the first diffraction grating 21 and the second diffraction grating 22 are moved relative to one another in the Y direction by applying a load, the interference fringes move in the Y direction. As a result, the PDs 41, 42, and 43 receive periodic light in which each set of light and dark constitutes one period.

FIG. 10 is a graph showing the output of the PDs 41, 42, and 43, where S1 is the output of the PD 41, S2 is the output of the PD 42, and S3 is the output of the PD 43. As illustrated in FIG. 10, because the grating lines 21a are shifted by ⅓ of one pitch and due to the arrangement of the PDs 41, 42, and 43, the light (S2) in the second region M2 is shifted by 90° in phase relative to the light (S1) in the first region M1, and the light (S3) in the third region M3 is shifted by 90° in phase relative to the light (S2) in the second region M2.

Thus in this embodiment, the PDs, 41, 42, and 43 are arranged in such way as to generate these phase differences in the received signals. The phase of the light (S3) in the third region M3 is shifted by 180° relative to the light (S1) in the first region M1, and therefore adding together the output of the PD 41 (the light received by the first region M1) and the output of the PD 43 (the light received by the third region M3) and dividing by two (that is, (S1+S3)/2) yields a DC value (reference value). This DC value fluctuates in accordance with any fluctuations that occur in the light emitted from the light source 12.

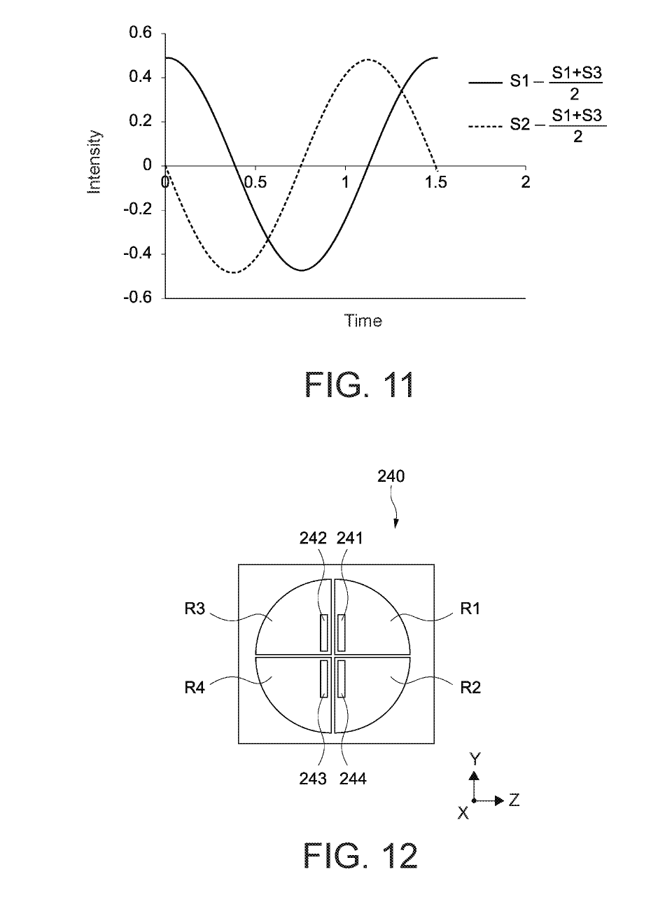

FIG. 11 is a graph showing a sine wave and a cosine wave obtained from the output of the PDs 41, 42, and 43. As illustrated in FIG. 11, subtracting the DC value from the output of the PD 41 (that is, S1−(S1+S3)/2) yields a sine wave, and subtracting the DC value from the output of the PD 42 (that is, S2−(S1+S3)/2) yields a cosine wave. The PDIC 40 then outputs voltage signals having these waveforms to the arithmetic processing circuit (not illustrated in the figures). The arithmetic processing circuit can then use this sine wave and cosine wave to calculate the displacement of the second diffraction grating 22 relative to the first diffraction grating 21.

<Effects>

Next, the effects of the displacement measuring device 100 according to the present embodiment will be described by way of comparison with a comparison example. In a displacement measuring device according to the comparison example, the configuration of the PDIC and the first diffraction grating are different than in the displacement measuring device according to the present embodiment. FIG. 12 schematically illustrates a PDIC 240 according to the comparison example. As illustrated in FIG. 12, the PDIC 240 includes four PDs 241, 242, 243, and 244.

Moreover, as also illustrated in FIG. 12, interference light incident on the PDIC 240 is divided into four regions: a first region R1, a second region R2, a third region R3, and a fourth region R4. The first diffraction grating according to the comparison example includes four grating pattern regions to give the interference light this shape.

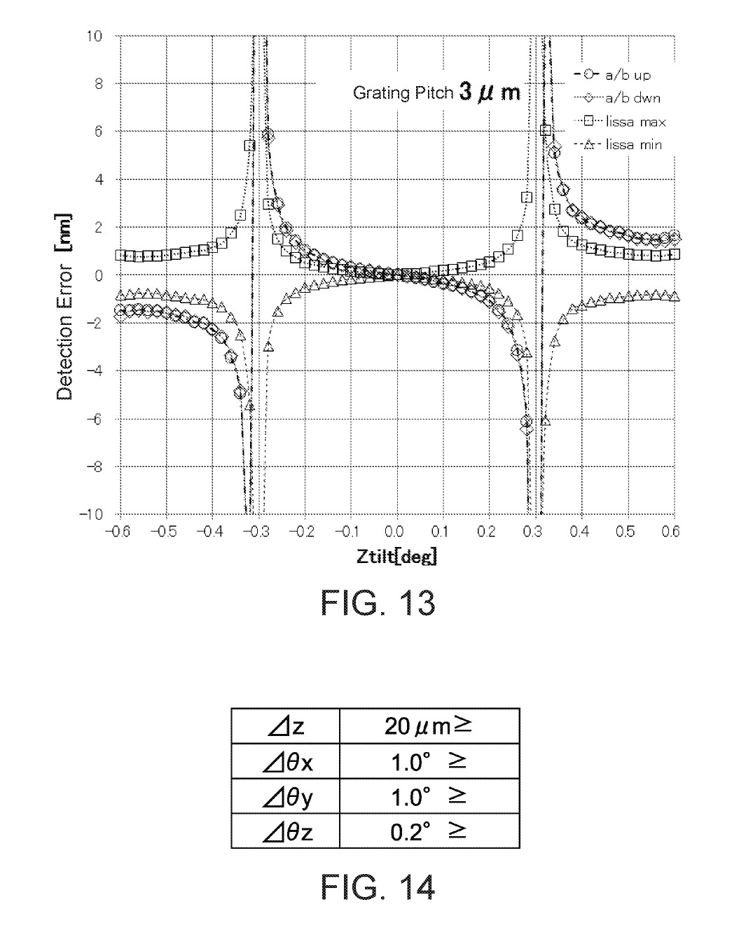

FIG. 13 is a graph showing the relationship between Z-tilt and detection error in the displacement measuring device according to the comparison example. As illustrated in FIG. 13, in order to achieve an accuracy of ±2 nm in the displacement measuring device according to the comparison example, the allowable Z-tilt is ±0.25°. Z-tilt is defined as a relative rotation angle of the diffraction gratings 21 and 22 about the axis extending in a direction in which the grating lines extend. Thus, the Z-tilt is expressed as the relative rotational angle of diffraction gratings 21 and 22 about the X-axis of FIG. 1.

FIG. 14 is a table showing defocus (ΔZ), X-tilt (Δθ_{X}), Y-tilt (Δθ_{Y}), and Z-tilt (Δθ_{Z}) values that make it possible to achieve a detection accuracy of ±2 nm in the displacement measuring device according to the comparison example. Here, Y-tilt is a relative rotation of the diffraction gratings 21 and 22 about the Z-axis shown in FIG. 1, and X-tilt is a relative rotation of the diffraction gratings 21 and 22 about the Y-axis shown in FIG. 1. As shown in FIG. 14, the defocus must be less than or equal to 20 μm and the Z-tilt must less than or equal to 0.2° in order to achieve a detection accuracy of ±2 nm in the configuration according to the comparison example. Therefore, if the Z-tilt exceeds 0.25° due to factors such as assembly accuracy during manufacturing, it is no longer possible to achieve a detection accuracy of ±2 nm.

Meanwhile, in the displacement measuring device 100 according to the present embodiment as described above, the PDs 41, 42, and 43 are arranged in the Y direction, and this arrangement direction is orthogonal to the direction in which the interference fringes extend (the Z direction at the PDIC 40). Therefore, the amounts of phase shift in the PDs are less affected by the Z-tilt (that is, the relative rotation of the diffraction gratings 21 and 22 about the X axis in FIG. 1), thus improving the Z-tilt margin.

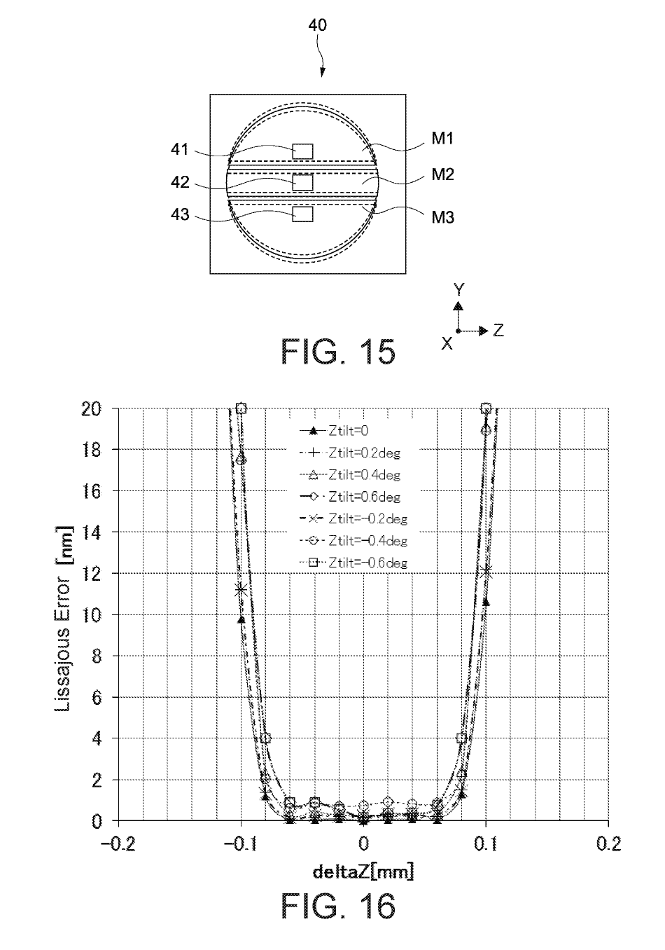

Moreover, in the displacement measuring device 100 as described above, the PDs 41, 42, and 43 are separated from one another in the Y direction. This reduces the effects of defocus (AZ). FIG. 15 schematically illustrates defocus in the interference light on the PDIC 40. As illustrated in FIG. 15, when defocus occurs, the interference light shifts in position (as indicated by the dashed lines). However, even in this case, the configuration still prevents deterioration of the interference light; that is, the configuration prevents the light in the first region M1 from reaching the PD 42 or the light in the second region M2 from reaching the PD 41, and prevents the light in the second region M2 from reaching the PD 43 or the light in the third region M3 from reaching the PD 42.

FIG. 16 is a graph showing the results of a simulated analysis of the correlation between Z-tilt, defocus, and accuracy, where the horizontal axis represents ΔZ (defocus) and the vertical axis represents Lissajous error. Here, “Lissajous error” refers to deviation from a perfect circle in a figure with sine values on the horizontal axis and cosine values on the vertical axis (a Lissajous figure). As illustrated in FIG. 16, when ΔZ is less than or equal to 80 μm, there is substantially no Lissajous error and no negative effects on measured values.

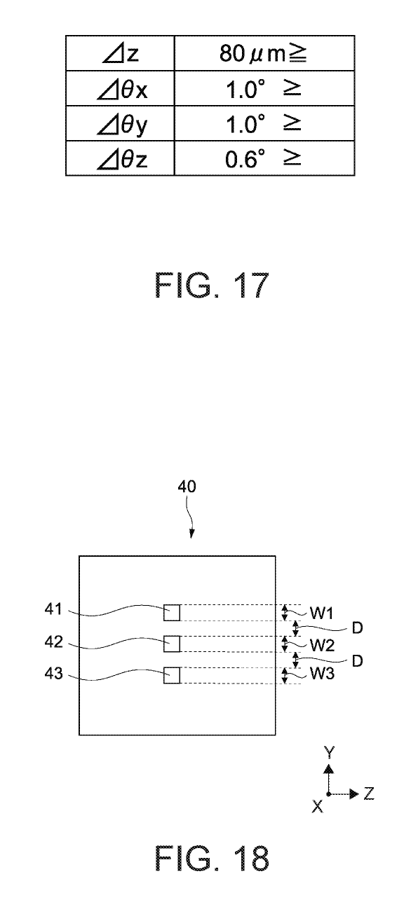

As also illustrated in FIG. 16, even a Z-tilt of 0.6° does not significantly affect the Lissajous error. FIG. 17 is a table showing the defocus (ΔZ), X-tilt (Δθ_{X}), Y-tilt (Δθ_{Y}), and Z-tilt (Δθ_{Z}) values that make it possible to achieve a detection accuracy of ±2 nm in the displacement measuring device 100.

Thus, the displacement measuring device 100 makes it possible to achieve a detection accuracy of ±2 nm as long as the defocus is less than or equal to 80 μm and the Z-tilt is less than or equal to 0.6°, which represents a significant increase in the defocus (ΔZ) and Z-tilt (Δθ_{Z}) margins relative to the comparison example described above (see FIG. 14).

<Spacing of PDs>

As described above, the PDs 41, 42, and 43 are separated from one another in the Y direction. The gaps between the PDs 41, 42, and 43 are not particularly limited but may be set to be approximately equal to the widths of the PDs 41, 42, and 43 in the Y direction.

FIG. 18 schematically illustrates the widths of and gaps between the PDs 41, 42, and 43. As illustrated in FIG. 18, letting a width W1 be the width of the PD 41 in the Y direction, a width W2 be the width of the PD 42 in the Y direction, and a width W3 be the width of the PD 43 in the Y direction, the widths W1, W2, and W3 are equal to one another.

Moreover, letting gaps D be the spacing between the PDs 41, 42, and 43 in the Y direction, the gaps D may be set to be equal to the widths W1, W2, and W3. Setting the gaps between the PDs 41, 42, and 43 to be relatively large in this manner makes deterioration of the interference light less likely to occur when defocus of the type illustrated in FIG. 15 occurs, thus reducing the potential negative effects of defocus (ΔZ).

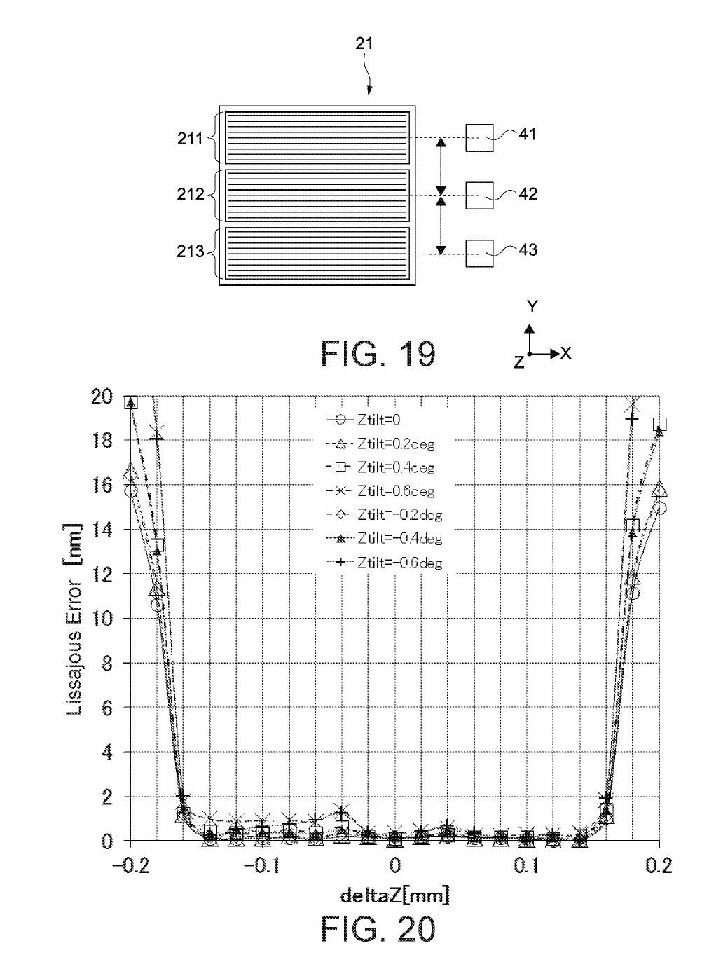

FIG. 19 schematically illustrates the first diffraction grating 21 and the PDs 41, 42, and 43 when they are arranged side by side according to another embodiment of the present invention. As illustrated in FIG. 19, when the gaps D are equal to the widths W1, W2, and W3, the center of the PD 41 may be aligned with the center of the grating pattern region 211 in the Y direction, and the respective centers of the PD 42 and the grating pattern region 212 as well as the respective centers of the PD 43 and the grating pattern region 213 align in a similar manner.

FIG. 20 is a graph showing the results of a simulated analysis of the correlation between Z-tilt, defocus, and accuracy for this case, where the horizontal axis represents ΔZ (defocus) and the vertical axis represents Lissajous error. As illustrated in FIG. 20, when ΔZ is less than or equal to 160 μm, there is substantially no Lissajous error and no negative effects on measured values.

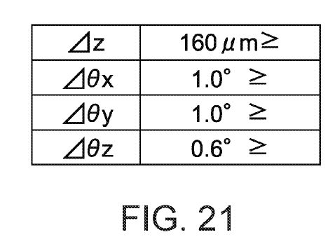

As also illustrated in FIG. 20, even a Z-tilt of 0.6° does not significantly affect the Lissajous error. FIG. 21 is a table showing the defocus (ΔZ), X-tilt (Δθ_{X}), Y-tilt (Δθ_{Y}), and Z-tilt (Δθ_{Z}) values that make it possible to achieve a detection accuracy of ±2 nm in the displacement measuring device 100.

Thus, the displacement measuring device 100 in which the gaps between the PDs 41, 42, and 43 are equal to the widths thereof makes it possible to achieve a detection accuracy of ±2 nm as long as the defocus is less than or equal to 160 μm and the Z-tilt is less than or equal to 0.6°, which represents a significant increase in the defocus and Z-tilt margins relative to the comparison example described above (see FIG. 14). Note also that the widths W1, W2, and W3 do not necessarily need to be the same.

### Modification Examples

In the embodiment described above, the first diffraction grating 21 is a transmissive diffraction grating and the second diffraction grating 22 is a reflective diffraction grating. However, the present invention is not limited to this example, and any configuration in which diffracted light produced by the first diffraction grating 21 creates interference upon reaching the second diffraction grating 22 may be used.

Moreover, in the embodiment described above, the direction in which displacements are measured is the direction in which the first diffraction grating 21 and the second diffraction grating 22 move relative to one another in the arrangement direction of the grating lines 21a and 22a. However, relative movement of the first diffraction grating and the second diffraction grating in the direction in which they themselves are arranged (Z direction in FIG. 1) also changes the intensity of the interference light in a corresponding manner. Therefore, in this case the displacement measuring device can detect this intensity change to measure the associated relative displacements.

Furthermore, although the light guiding member 31 and the prism mirror 35 are connected together as a single integrated component in the embodiment described above, these components may be separate. In addition, instead of the prism mirror 35, an absorptive member capable of absorbing light may be integrated with or provided separately from the light guiding member 31.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A displacement measuring device, comprising:
a first diffraction grating that receives light from a light source, the first diffraction grating including a plurality of grating pattern regions respectively having prescribed diffraction grating patterns, grating pitches of the plurality of grating pattern regions being equal to one another, the plurality of grating pattern regions being arranged in a direction that is orthogonal to a direction in which the prescribed diffraction grating patterns extend;
a second diffraction grating that produces interference light upon receiving diffracted light rays emitted from the first diffraction grating; and
a light detector that receives the interference light emitted from the second diffraction grating, the light detector including a plurality of photodetectors, the plurality of photodetectors being arranged along a first direction that is orthogonal to a direction in which interference fringes created by the interference light extend.

2. The displacement measuring device according to claim 1, wherein the plurality of photodetectors are separated from one another along the first direction by gaps equal to widths of the photodetectors in the first direction.

3. The displacement measuring device according to claim 1, wherein the plurality of grating pattern regions includes a first grating pattern region, a second grating pattern region, and a third grating pattern region, the second grating pattern region having a diffraction grating pattern that creates a 90° phase shift in the interference light relative to the interference light created by a diffraction grating pattern of the first grating pattern region, and the third grating pattern region having a diffraction grating pattern that creates a 180° phase shift in the interference light relative to the interference light at the corresponding photodetector created by the diffraction grating pattern of the first grating pattern region.

4. The displacement measuring device according to claim 3, wherein the plurality of photodetectors includes a first photodetector, a second photodetector, and a third photodetector, the first photodetector receiving light emitted from the first grating pattern region, the second photodetector receiving light emitted from the second grating pattern region, and the third photodetector receiving light emitted from the third grating pattern region.

5. The displacement measuring device according to claim 1, further comprising:
an optical member that includes a parallel pair of reflective surfaces facing one another and that is configured to respectively reflect ±mth-order diffracted light rays off of the pair of reflective surfaces to guide the light rays to the second diffraction grating, the ±mth-order diffracted light rays being a prescribed order of diffracted light rays among a plurality of orders of the diffracted light rays emitted from the first diffraction grating, and m being a natural number.

6. The displacement measuring device according to claim 1, further comprising:
a processing circuit that calculates a displacement of the second diffraction grating relative to the first diffraction grating on the basis of output of the plurality of photodetectors.

7. A method of measuring displacement, comprising:
preparing a displacement measuring device that includes:
a first diffraction grating that receives light from a light source, the first diffraction grating including a plurality of grating pattern regions respectively having prescribed diffraction grating patterns, grating pitches of the plurality of grating pattern regions being equal to one another, the plurality of grating pattern regions being arranged in a direction that is orthogonal to a direction in which the prescribed diffraction grating patterns extend;
a second diffraction grating that produces interference light upon receiving diffracted light rays emitted from the first diffraction grating; and
a light detector that receives the interference light emitted from the second diffraction grating, the light detector including a plurality of photodetectors, the plurality of photodetectors being arranged along a first direction that is orthogonal to a direction in which interference fringes created by the interference light extend; and
calculating a displacement of the second diffraction grating relative to the first diffraction grating on the basis of output of the plurality of photodetectors.
